(19) United States
(12) Patent Application Publication
(10) Pub. No.: US 2002/0029931 A1
(43) Pub. Date: Mar. 14, 2002

(54) Tree screw adapter

(76) Inventor: Kevin E. Bridges, Perry, MI (US)

Correspondence Address: HARNESS, DICKEY & PIERCE, PLC, P.O. BOX 828, BLOOMFIELD HILLS, MI, 48303, US

(21) Appl. No.: 09/949,699

(22) Filed: Sep. 10, 2001

Related U.S. Application Data
(60) Provisional application No. 60/231,699, filed on Sep. 11, 2000.

(51) Int. Cl. E06C 9/00

(52) U.S. Cl. 182/92; 182/187

(57) ABSTRACT

A selectively detachable unitary tree screw adapter for use in association with tree screws of varying shapes and sizes is provided. The tree screw adapter generally includes a tubular body including an ergonomic outer surface and an axial bore extending therethrough. Formed into the body are a plurality of slots that provide access through the body from the axial bore. Upon attaching the tree screw adapter over the elongated shank of a tree screw, the tree screw can be installed or removed from the trunk of a tree with improved efficiency.

### FIELD OF THE INVENTION

The present invention relates to an adapter for installing and removing screws having an accessible shank and, more particularly, to a unitary tree screw adapter useful in association with tree screws of varying shapes and sizes.

### BACKGROUND OF THE INVENTION

Substantially Z-shaped tree screws including a threaded end and an elongated shank have been used as steps for many years by hunters and other nature lovers to assist in climbing trees. Such tree steps are often attached along opposite sides of a tree trunk to allow one to climb into a tree in a stepwise fashion. These devices, along with screws having a T-shaped shank and a threaded terminal end are also commonly employed as anchoring mechanisms for hanging feeders, seats or stands, among other practical uses.

Unfortunately, the aforementioned tree screws are often difficult to install, in part because it is difficult to grip conventional tree screws, particularly in inclement weather. Further, such tree screws become difficult to remove over time due to expansion and contraction of the tree trunk as a result of varying weather conditions or changes in the structure of the tree itself.

Thus, there is a need for an adapter that can be used with a wide variety of conventional wood screws, tree screws or log bolts, by way of non-limiting examples, which improves the installation and/or removal efficiency of such devices.

### SUMMARY OF THE INVENTION

The present invention therefore comprises an adapter having a substantially tubular body including an ergonomic outer surface and an axial bore extending therethrough. The tubular body is provided with at least one and preferably a plurality of slots extending from the axial bore that allows for protrusion of the shank portion of the screw upon attachment. Optionally, a cord or soft wire loop may be extended from the tubular body as a means of securing the adapter to a person's wrist or clothing during periods of non-use.

As should be readily recognized, the adapter of the present invention will provide an improved way of installing and removing conventional threaded devices and particularly threaded tree steps and anchoring mechanisms.

Another object of the present invention is to provide an adapter that is useful with a variety of threaded devices of differing shapes and design.

Yet another object of the present invention is to provide an adapter which is formed from a low cost, highly durable material. Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an assembled perspective view showing the adapter of the present invention attached to a threaded fastener for securing a seat to a tree;

FIG. 2 is an enlarged view of the adapter of FIG. 1;

FIG. 3 is a perspective view of the adapter shown in various positions during rotation of a threaded tree step;

FIG. 4 is a side view of the adapter of the present invention;

FIG. 5 is a side view of the adapter engaging a threaded tree step having a long flared end;

FIG. 6 is a side view of the adapter engaging a standard flare threaded tree step having a short flared end;

FIG. 7 is a front view of the adapter of FIG. 7 engaging a threaded tree screw; and

FIG. 8 is a cross-sectional view of the adapter engaging a threaded tree screw.

### DETAILED DESCRIPTION OF THE PREFERRED EMBODIMENTS

The following description of the preferred embodiment(s) is merely exemplary in nature and is in no way intended to limit the invention, its application, or uses.

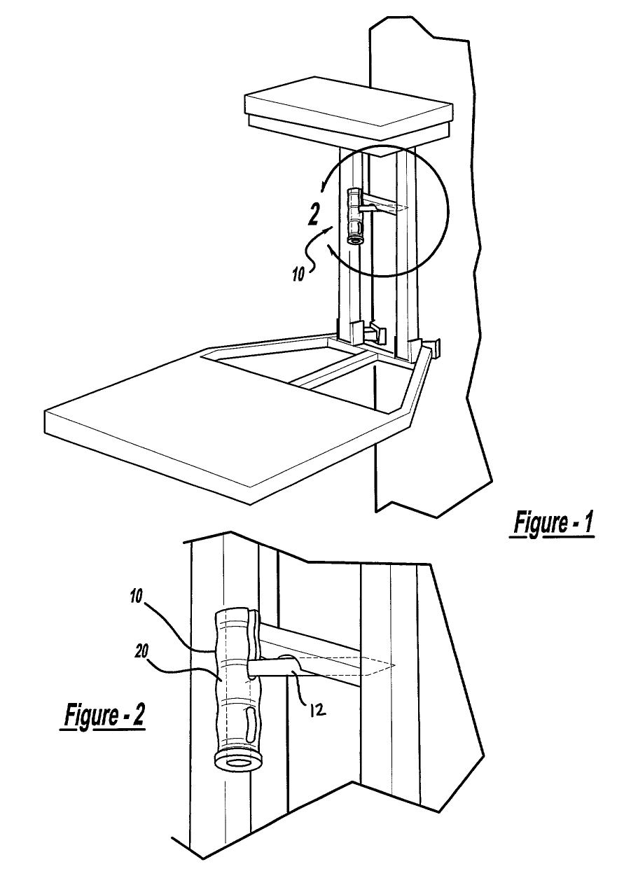

Referring to FIGS. 1-8, there is shown a universal adapter 10 for use in association with various fasteners 12 including an elongated shank 14 and a threaded terminal portion 16. The fasteners 12 for which the adapter of the present invention is particularly useful are referred to by hunters and the like as tree steps and tree screws. Among the various tree steps in use, the adapter can be used with both substantially Z-shaped threaded tree steps and T-shaped screws, among others.

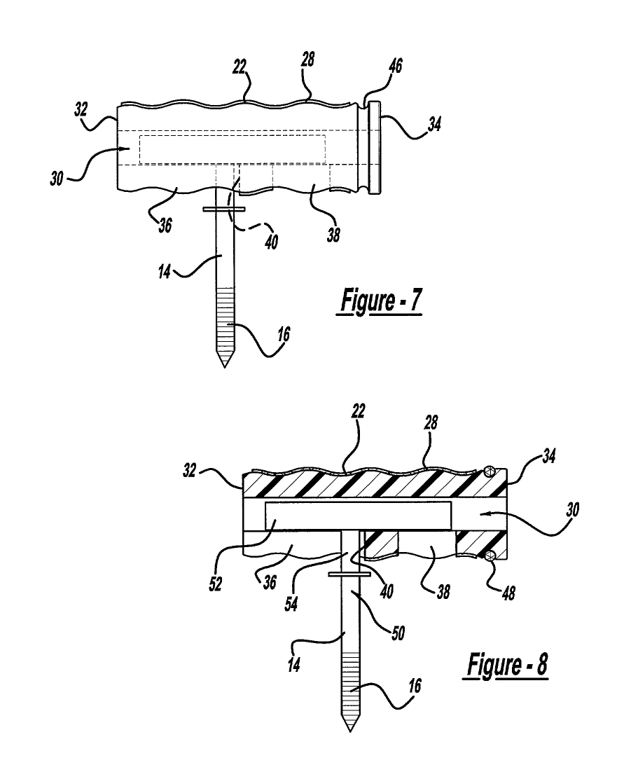

The adapter 10 includes a substantially tubular body 20 of sufficient length to be comfortably gripped by a person's hand. Preferably, the tubular body will include an outer surface 22 that includes a plurality of rounded convolutions 24 spaced apart to provide an ergonomic grip 26. The adapter 10 is generally formed by injection molding a thermoplastic material such as polyethylene, polypropylene, polycarbonate or polyethylene terephthalate, by way of non-limiting examples. If desirable, an elastomeric non-slip material 28 such as a coating or pre-cast sleeve as shown in FIGS. 7 and 8, may be applied over the outer surface 22 to improve the gripability of the adapter.

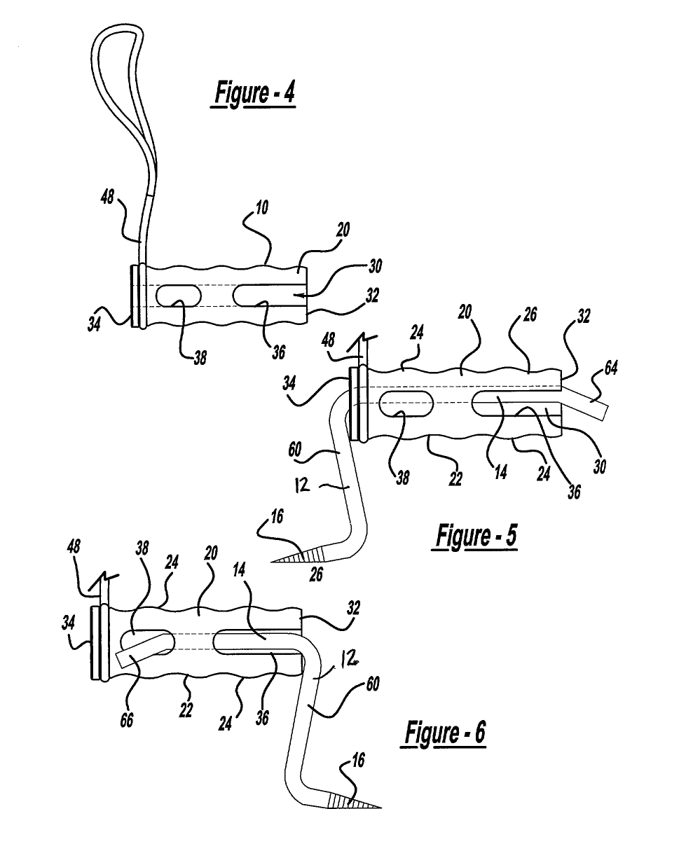

The adapter 10 also generally includes an axial bore 30 extending at least partially through the body and, preferably, the entire length of the body 20 from first end 32 to second end 34 as illustrated most clearly with reference to FIG. 8. Extending from the axial bore is at least one slot 36 for receiving terminal portion of the fastener if necessary. Preferably, the adapter 10 includes a plurality of such slots. For example, extending from the first end of the body into the axial bore is a first elongated slot 36. Optionally, but preferably, a second slot 38 which is shorter than the first slot is provided between the first elongated slot 36 and the second end 34 of the adapter. While the second slot is preferably provided along the same axis as the first elongated slot, it should be understood by those of ordinary skill in the art that the position of the second slot relative to the first slot may vary; e.g., it need not be along the same axis for many useful applications. Additionally, the outer surface of the body also includes an annular groove 46, as shown most clearly in FIG. 7, transverse to the axial bore which is located between the second slot and the second end of the body for hosting an attachment cord 48 as shown in FIG. 4.

In view of the above described construction of the adapter 10, various uses of the product will now be described. Referring to FIGS. 7 and 8, the adapter 10 can be used with a T-shaped screw 50 by sliding the cross bar portion 52 of the shank 14 into the axial bore 30 until the transverse portion 54 of the shank engages the abutting wall 40 of the first slot 36. With the adapter applied in this manner and the threaded portion 16 extending freely from the adapter, the T-screw can be rotated with additional torque, thereby allowing for more convenient attachment and removal of the T-screw from a substrate such as a tree trunk.

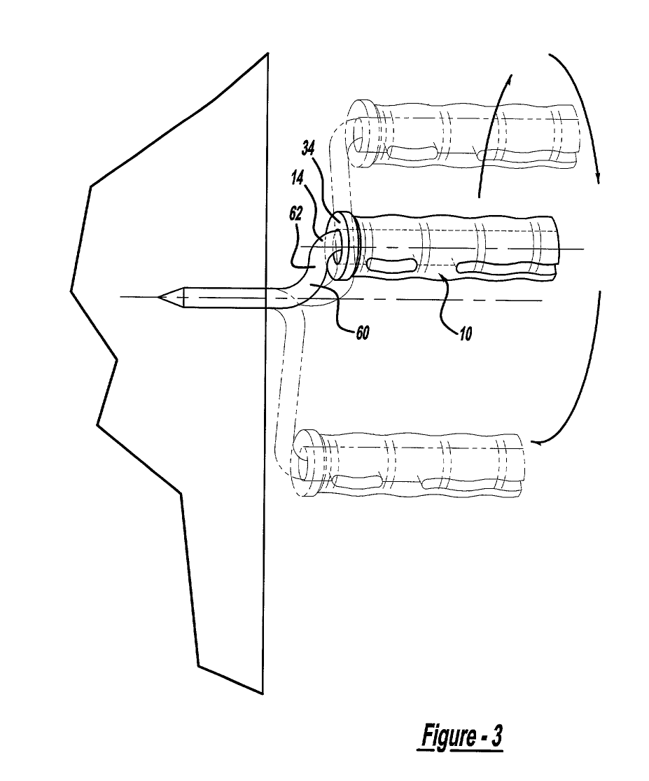

To utilize the adapter 10 with Z-shaped tree steps 60, the shank 14 can be inserted into the axial bore 30 either through the first end 32 or the second end 34, depending on whether the tree screw is standard, has a short flared end or a larger flared end. For example, as shown in FIG. 3, the shank 14 of a standard tree step 60 is inserted into the second end 34 of the adapter until the bent portion 62 of the tree step is in proximity to the second end.

By way of comparison, a tree step 60 having a large flared end 64 may also be inserted into the axial bore 30 along the second end of the adapter generally until the bent portion 60 is in proximity to the second end. This allows the large flared end 64 to extend into the elongated slot 30, thus precluding radial movement of the tree step during rotation.

Under yet another application, particularly for tree steps having a short flared end 66 as shown in FIG. 6, it may be useful to insert the shank 14 of the step into the first end 32 of the adapter 10. The shank is inserted until the short flared end extends into the second slot 38 of the adapter, again helping to preclude radial movement of the tree step during rotation.

As should now be well understood by those of ordinary skill in the art, the adapter of the present invention can be used with a variety of threaded fasteners such as T-screws and tree steps, by way of non-limiting example, to facilitate rotation for purposes of installing or removing the fasteners from the desired substrate. Thus, the description of the invention is merely exemplary in nature and, thus, variations that do not depart from the gist of the invention are intended to be within the scope of the invention. Such variations are not to be regarded as a departure from the spirit and scope of the invention.

What is claimed is:

1. An adapter for facilitating rotation of a fastener having an elongated shank, said adapter comprising:
a generally tubular body defining an outer surface and an axial bore, said axial bore extending at least partially therethrough said body, said body including at least one slot extending through said outer surface to said axial bore;
wherein the elongated shank is received in said axial bore.

2. The adapter of claim 1 wherein said outer surface includes a plurality of spaced apart convolutions to provide said adapter with an ergonomic grip.

3. The adapter of claim 1 wherein said outer surface is provided with an elastomeric non-slip material.

4. The adapter of claim 1 wherein said at least one slot includes a first slot terminating at said first end of said body and a second slot disposed between said first slot and said second end of said body.

5. The adapter of claim 4 wherein the length of said second slot is shorter than the length of said first slot.

6. The adapter of claim 1 including an annular groove for seating an attachment cord.

7. The adapter of claim 1 wherein said body is formed from injection molded thermoplastic.

8. The adapter of claim 1 wherein a portion of the elongated shank disposable within said at least one slot.

9. The adapter of claim 1 wherein said axial bore extends from a first end of said body to a second end of said body.

10. An adapter for facilitating rotation of a fastener having an elongated shank, said adapter comprising:
a generally tubular thermoplastic body defining an outer surface and an axial bore, said axial bore extending from a first end of said body to a second end of said body, said body including a first slot and a second slot extending through said outer surface to said axial bore;
wherein the elongated shank is received in said axial bore with a portion of the elongated shank disposable within one of said first and second slots.

11. The adapter of claim 10 wherein said outer surface includes a plurality of spaced apart convolutions to provide said adapter with an ergonomic grip.

12. The adapter of claim 10 wherein said outer surface is provided with an elastomeric non-slip material.

13. The adapter of claim 10 wherein said first slot terminates at said first end of said body and said second slot is disposed between said first slot and said second end of said body.

14. The adapter of claim 13 wherein the length of said second slot is shorter than the length of said first slot.

15. The adapter of claim 10 including an annular groove for seating an attachment cord.

16. An adapter for facilitating rotation of a tree fastener having an elongated shank and a threaded terminal end, said adapter comprising:
a generally tubular thermoplastic body defining an outer surface and an axial bore including a plurality of spaced apart convolutions to provide said adapter with an ergonomic grip, said axial bore extending from a first end of said body to a second end of said body, said body including a first slot and a second slot extending through said outer surface to said axial bore such that said first slot terminates at said first end of said body and said second slot is disposed between said first slot and said second end of said body;
wherein the elongated shank is received in said axial bore with a portion of the elongated shank disposable within said at least one of said first and second slots.

17. The adapter of claim 16 wherein said outer surface is provided with an elastomeric non-slip material.

18. The adapter of claim 19 wherein the length of said second slot is shorter than the length of said first slot.

19. The adapter of claim 17 including an annular groove for seating an attachment cord.
